(19) United States
(12) Patent Application Publication
(10) Pub. No.: US 2013/0194108 A1
(43) Pub. Date: Aug. 1, 2013

(54) System, Method, Control Device and Program for Vehicle Collision Avoidance Using Cellular Communication

(71) Applicants: George Lapiotis, Astoria, NY (US); Jyh-Cheng Chen, Hsinchu (TW); Hanan Luss, Monroe, NJ (US); Tao Zhang, Fort Lee, NJ (US)

(72) Inventors: George Lapiotis, Astoria, NY (US); Jyh-Cheng Chen, Hsinchu (TW); Hanan Luss, Monroe, NJ (US); Tao Zhang, Fort Lee, NJ (US)

(73) Assignee: Telcordia Technologies, Inc., Piscataway, NJ (US)

(21) Appl. No.: 13/361,080

(22) Filed: Jan. 30, 2012

(51) Int. Cl. G08G 1/0967

(52) U.S. Cl. 340/905

(57) ABSTRACT

Avoiding vehicle collisions using an in-vehicle device is provided. The method comprises receiving a connection request from an in-vehicle device within a moving vehicle when the moving vehicle is within a selected distance from a traffic intersection, establishing connection with the in-vehicle device within a moving vehicle via a serving base station, receiving position information from the in-vehicle device within a moving vehicle corresponding to a position of the moving vehicle, receiving control information for a traffic light at the traffic intersection from a traffic management center and relaying the control information for the traffic light to the in-vehicle device within a moving vehicle. A warning is issued based upon a vehicle speed, a location and a position relative to a traffic intersection. A warning is also issued based upon multiple vehicles speed, relative locations to each other and each position relative to a traffic intersection.

### FIELD OF THE INVENTION

This invention relates to systems, methods, devices and programs for avoiding vehicle collisions. In particular, the invention is related to systems, methods, devices and programs which use cellular communication to avoid collisions between vehicles at traffic intersections.

### BACKGROUND OF THE INVENTION

In spite of extensive traffic rules, substantial traffic control infrastructure, such a traffic lights and stop signs, vehicle collisions still occur at an alarming rate. These vehicle collisions cause injuries to the drivers and passengers, damage to the vehicles and traffic delays. Collisions also cause an increase in the traffic flow on the roadways due to emergency vehicles and tow vehicles responding to the collisions.

### SUMMARY OF THE INVENTION

Accordingly, disclosed is a method of avoiding vehicle collisions comprising receiving a connection request from an in-vehicle device within a moving vehicle when the moving vehicle is within a selected distance from a traffic intersection, establishing connection with the in-vehicle device within a moving vehicle via a serving base station, receiving position information from the in-vehicle device within a moving vehicle corresponding to a position of the moving vehicle, receiving control information for a traffic light at the traffic intersection from a traffic management center and relaying the control information for the traffic light to the in-vehicle device within a moving vehicle.

Once a connection is established, the position information is periodically received.

The method further comprises determining a speed of the moving vehicle based upon the periodically received position information, determining if a notification to an in-vehicle device within a moving vehicle should be issued based upon the determined speed and the received position information and transmitting the notification to the in-vehicle device based upon the determination.

Additionally, more than one connection request can be received from multiple in-vehicle devices. If more than one connection request is received, the method comprises establishing connection with each of the plurality of in-vehicle devices via at least one serving base station based upon available bandwidth, receiving position information from each of the plurality of in-vehicle devices corresponding to a position of the of each of corresponding moving vehicles, receiving control information for at least one traffic light at a corresponding traffic intersection from a traffic management center, and relaying the control information for the at least one traffic light at the corresponding traffic intersection to each of the plurality of in-vehicle devices via the at least one serving base station. The corresponding traffic intersection is determined based upon the position information for each of the plurality of in-vehicle devices.

The method further comprises transmitting the position information from each of the plurality of in-vehicle devices received, as aggregate position information for each of the plurality of in-vehicle devices, to each of the plurality of in-vehicle devices.

The method further comprises determining a speed for each of corresponding vehicles, determining if a notification to an in-vehicle device within a moving vehicle should be issued based upon the determination for each of the corresponding moving vehicles and the position information received and transmitting the notification to each of the plurality of in-vehicle devices based upon the determination.

The method further comprises determining a total number of in-vehicle devices having an active connection via each of the at least one base stations, comparing the total number of in-vehicle devices with a maximum number simultaneously connectable in-vehicle devices; and dropping a sub-set of in-vehicle devices from the active connection based upon the determination. The dropping can be based upon a current location of an in-vehicle device and a current speed of the corresponding moving vehicle. Alternatively, the dropping is based upon a random selection of an in-vehicle device.

The method further comprises determining the selected distance based upon traffic patterns and traffic density.

Also disclosed is a method of avoiding vehicle collisions comprising issuing a connection request to a central controller from a moving vehicle when a moving vehicle is within a selected distance from a traffic intersection, establishing connection with the central controller via a serving base station, obtaining position information for the moving vehicle and transmitting the same to the central controller and receiving control information for a traffic light at the traffic intersection from the central controller.

The method further comprises determining if a warning should issue based upon the position information and control information for a traffic light received and generating a notification based upon the determining.

The method further comprises receiving position information for all other vehicles within a distance of the traffic intersection and determining if a warning should issues based upon the position information for the moving vehicle, the position information for all other vehicles within a distance of the traffic intersection received and control information for a traffic light received and generating a warning based upon the determining.

The position information includes a speed, a direction of travel and current location. The control information for a traffic light includes phase and time data. Once a connection is established, the position information is periodically transmitted.

The method further comprises determining the selected distance based upon a current speed of a moving vehicle.

The method farther comprises terminating any non-collision avoiding communications in an in-vehicle device prior to generating the notification.

Also disclosed is a vehicle collision avoidance management device comprising a processor configured to, when executing computer readable instructions provide: a connection management section configured to manage simultaneous connectivity of a plurality of in-vehicle devices within moving vehicles with the vehicle collision avoidance management device based upon a number of the plurality of in-vehicle devices within moving vehicles having active connections with the vehicle collision avoidance management device at a given time through each of a plurality of serving base stations, a first receiving section configured to receive traffic signal control information for traffic signals at each of a plurality of traffic intersections, a second receiving section configured to receive communications from each of a plurality of in-vehicle devices within moving vehicles when a corresponding vehicle is within a selected distance of an intersection, the communications including location information and a transmitting section configured to transmit the traffic signal control information for traffic signals to each of the plurality of in-vehicle devices and to transmit the communications received from each of the plurality of in-vehicle devices to each of the other of the plurality of in-vehicle devices.

The vehicle collision avoidance management device further comprises a collision detection section configured to generate a collision warning to at least one of the plurality of in-vehicle devices based upon the traffic signal control information and the communications received from each of the plurality of in-vehicle devices. The transmitting section is configured to transmit the collision warning to at least one of the plurality of in-vehicle devices.

The connection management section is further configured to selectively drop a sub-set of in-vehicle devices from the active connection when a number of active connections exceed a variable maximum number. The drop is based upon a current location of an in-vehicle device and current speed of a corresponding moving vehicle. The drop is based upon a random selection of an in-vehicle device.

The vehicle collision avoidance management device further comprising a distance determining section configured to periodically determine the selected distance based upon traffic patterns and traffic density.

Also disclosed is a computer readable storage device having computer readable instructions for causing a processor to execute a method of receiving a connection request from an in-vehicle device within a moving vehicle when the moving vehicle is within a selected distance from a traffic intersection, establishing connection with the in-vehicle device within the moving vehicle via a serving base station, receiving position information from the in-vehicle device within the moving vehicle corresponding to a position of the moving vehicle, receiving control information for a traffic light at the traffic intersection from a traffic management center and relaying the control information for the traffic light to the in-vehicle device within a moving vehicle.

Also disclosed is a computer readable storage device having computer readable instructions for causing a processor to execute a method of issuing a connection request to a central controller from a moving vehicle when a moving vehicle is within a selected distance from a traffic intersection, establishing connection with the central controller via a serving base station, obtaining position information for the moving vehicle and transmitting the same to the central controller and receiving control information for a traffic light at the traffic intersection from the central controller. The method further comprises receiving position information for all other vehicles within a distance of the traffic intersection, determining if a warning should issue based upon the position information, the position information for all other vehicles within a distance of the traffic intersection received and the control information for a traffic light received and generating a warning based upon the determining.

### BRIEF DESCRIPTION OF THE DRAWINGS

These and other features, benefits, and advantages of the present invention will become apparent by reference to the following figures, with like reference numbers referring to like structures across the views, wherein:

FIG. 1 illustrates an exemplary vehicle collision avoidance system for one traffic intersection in accordance with the invention;

FIG. 2 illustrates a block diagram of an exemplary mobile communication device in accordance with the invention;

FIG. 3 illustrates a block diagram of an exemplary central controller in accordance with the invention;

FIG. 4 illustrates a block diagram of an exemplary vehicle collision avoidance system in accordance with the invention;

FIGS. 5 and 6 illustrate flow charts for a collision avoidance method according to a first example of the invention;

FIGS. 7 and 8 illustrate flow charts for a collision avoidance method according to a second example of the invention;

FIGS. 9 and 10 illustrate flow charts for a collision avoidance method according to a third example of the invention; and

FIGS. 11 and 12 illustrate flow charts for a collision avoidance method according to a fourth example of the invention.

### DETAILED DESCRIPTION OF THE INVENTION

The vehicle collision avoidance system (referenced as “100”) uses an in-vehicle communications device (referenced as “200”), to timely alarm vehicle drivers of a hazardous situations when approaching a road intersection. Hazardous situations include, but are not limited to, vehicles crossing the intersection when the traffic light is yellow or red, not stopping at a stop sign or a red light, making illegal turns, crossing pedestrians, and road geometry hindering drivers' ability to see other vehicles. Active accident prevention measures are used to timely alert drivers of hazardous situations at intersections.

The vehicle collision avoidance system 100 provides an in-vehicle communications device 200 with traffic Signal Phase and Timing (SPAT) information when a vehicle 1 approaches an intersection 35. The information is provided when the vehicle 1 reaches a predetermined distance from the intersection 35. This information can be used to alert drivers of a signed intersection such as a stop sign ahead. Additionally, the SPAT information is combined with a vehicle's own and other vehicles' positions, speeds and directions to detect the hazardous situations described above.

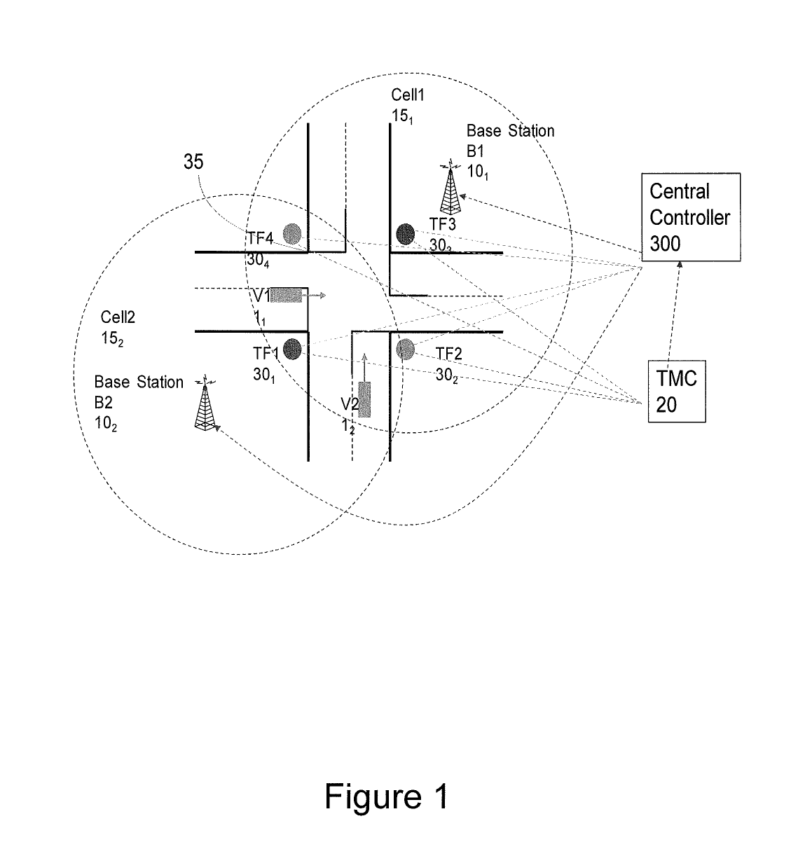

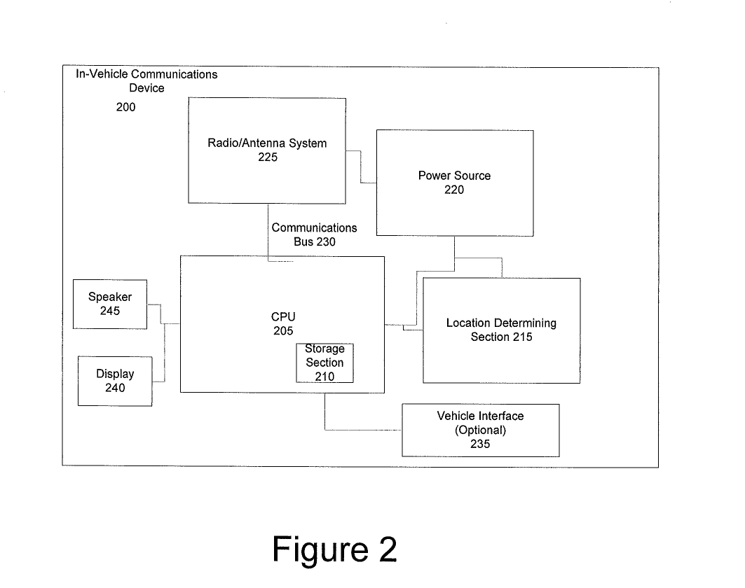

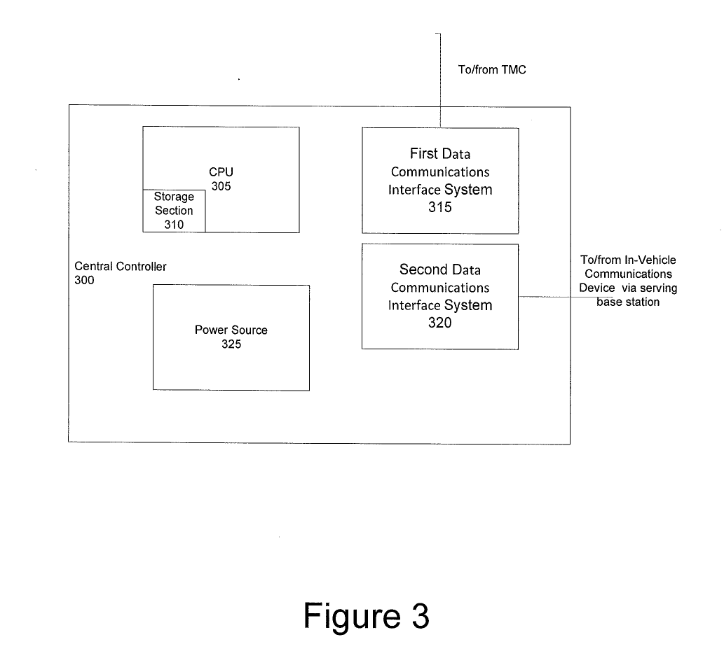

FIG. 1 illustrates an exemplary traffic intersection 35 having a vehicle collision avoidance system 100. FIG. 1 depicts two vehicles V1 and V2 (vehicles are collectively referenced as “1”). Each vehicle 1 e.g. V1 and V2, has an in-vehicle communications device 200. The in-vehicle communications device 200 will be described later in FIG. 2. The traffic intersection 35 includes four directional traffic lights TF1-TF4 30₁₋₄. Each traffic light is controlled by a traffic management center 20 (“TMC”). The TMC 20 is configured to communicate with a central controller 300 to provide the SPAT information. The TMC 20 can communicate with the central controller 300 via a wired or wireless network. The TMC 20 generates the traffic signal phases and timing plans used by the traffic lights 30. The central controller 300 will be described in detail in FIG. 3.

The in-vehicle communications devices 200 can communicate with the central controller 300 via one serving base station (collectively referenced as “10”) at a time. Two serving base stations 10 e.g., BS1 and BS2, are depicted in FIG. 1. However, any number of serving base stations 10 can be used. The maximum number of allowable connections (simultaneously) is divided among a plurality of traffic intersections 35. The number of allowable connected devices at each intersection is continuously updated based upon traffic patterns and density.

Each base station 10 has wireless cellular coverage within a cell, i.e., cell 1 and cell 2 (collectively referenced as “15”). At an intersection 35, there are at least two overlapping cells from two different serving base stations 10. Although FIG. 1 illustrates that the two cells overlap, there is no need for cells to overlap. Additionally, one base station can cover multiple intersections. The overlapping cells can provide redundancy.

FIG. 2 illustrates an exemplary in-vehicle communications device 200. The in-vehicle communications device 200 can be a mobile device carried by a vehicle driver or mounted to a vehicle temporarily or permanently. For example, the in-vehicle communications device 200 can be a cellular telephone, PDA or smartphone, portable GPS navigation device; laptop computer, pager, or the like.

Additionally, the in-vehicle communications device 200 can be a device internal to the vehicle such as an on-board navigation system. The in-vehicle communications device 200 includes a processor, e.g., CPU 205 with a storage section 210, a location determining section 215, a Radio/Antenna System 225, a power source 220, a communications bus 230, a display 240 and a speaker 245. Optionally, if the in-vehicle communications device 200 is a mobile or portable device, a vehicle interface (IWO) 235 (“vehicle I/O”) can be included. Additionally, although not depicted, the in-vehicle communications device 200 can also have a user interface such as, but not limited to, a telephone or a cellular phone keypad and a text keypad.

The Radio/Antenna system 225 is for providing wireless communication when the in-vehicle communications device 200 is within the cell coverage area 15 of a serving base station 10, e.g., communicating with the central controller 300. The radio/antenna system 225 can be 2.5G, 3G, 3.5G or 4G. For example, the in-vehicle communications device 200 can use 4G of Long Term Evolution (LTE) type for communication with the central controller 300 via its serving base station 10. However, implementation with other wireless cellular technologies of a previous or future generation can be used.

The CPU 205 can be any type of controller such as, but not limited to, a microcontroller or a microprocessor. The CPU 205 provides operational control by executing instructions, which have been programmed. A storage section 210 is disposed within the CPU 205 and in operational communication with the same. The storage section 210 may be memory modules, removable media or a combination of multiple storage devices, etc., and is configured to store the processor-executable instructions necessary for the performance of the methods and protocols described herein.

The in-vehicle communications device 200 includes a location determining section 215 such as a GPS device. Further, the CPU 205 can calculate the speed and compass direction of the vehicle 1 using information from the location determining section 215. Alternatively, the location determining section 215 can be external such as one located in a vehicle 1 and the location information transmitted to the in-vehicle communications device 200 through the vehicle I/O 235. In this case, information such as, but not limited to, location, compass direction and speed can also be transmitted to the in-vehicle communications device 200 from the vehicle 1 via the vehicle I/O 135. Alternatively, a digital compass can be included in the in-vehicle communications device 200.

A power source 220 is electrically connected to all the components of the in-vehicle communications device 200 to provide operational power to the components as necessary. The in-vehicle communications device 200 can include an internal clock (not shown) that maintains a clock for the device and is used as the timestamp for all messages.

The processor-executable instructions for performing the described functionality may be embedded in the storage section 210 in a form such as an EPROM, Flash memory or other such non-volatile storage. Additionally, the processor-executable instructions may be stored on a computer readable storage device such as an optical or magnetic medium. Additionally, the processor-executable instructions can be periodically updated in order to provide additional enhancements to the in-vehicle communications device 200 as they become available.

Each in-vehicle communications device 200 is assigned a unique identifier to facilitate the transmission and reception of messages. The unique identifier can be any number that is uniquely assigned to the in-vehicle communications device 200 so that no device within a specific area has the same unique identifier. The unique identifier can be any unique number or address that facilitates communication, such as a MAC address, VIN number or IP address, this identifier is used as the node's identifier. The display 240 and/or speaker(s) 245 are used for issuing an alert or notification to the driver.

FIG. 3 illustrates an exemplary central controller 300. The central controller 300 includes a CPU 305, a storage section 310, first and second data communications interface systems 315 and 320 and a power source 325. The first data communications interface system 315 is configured to communicate with the TMC 20. The connection can be a wired or wireless connection. The second data communications interface system 320 is configured for communication with the in-vehicle communications devices 200 via at least one serving base station 10. The second data communications interface system 320 receives location information from the in-vehicle communications devices 200 via the serving base stations 10 and transmits the SPAT information to the in-vehicle communications devices 200. The second data communications interface system 320 can communicate with the in-vehicle communications devices 200 using a uni-cast (point-to-point), multi-cast (point-to-multiple points) or broadcast type of communication.

The CPU 305 can be any type of controller such as, but not limited to, a microcontroller or a microprocessor. The CPU 305 provides operational control by executing instructions, which have been programmed. A storage section 310 is disposed within the CPU 305 and in operational communication with the same. The storage section 310 may be memory modules, removable media or a combination of multiple storage devices, etc., and is configured to store the processor-executable instructions necessary for the performance of the methods and protocols described herein.

The processor-executable instructions for performing the described functionality may be embedded in the storage section 310 in a form such as an EPROM, Flash memory or other such non-volatile storage. Additionally, the processor-executable instructions may be stored on a computer readable storage device such as an optical or magnetic medium. Additionally, the processor-executable instructions can be periodically updated in order to provide additional enhancements to the central controller 300 as they become available.

The central controller 300 also has a unique identifier assigned which is used to transmit and receive messages. This identifier is apriori known by each in-vehicle communications device 200.

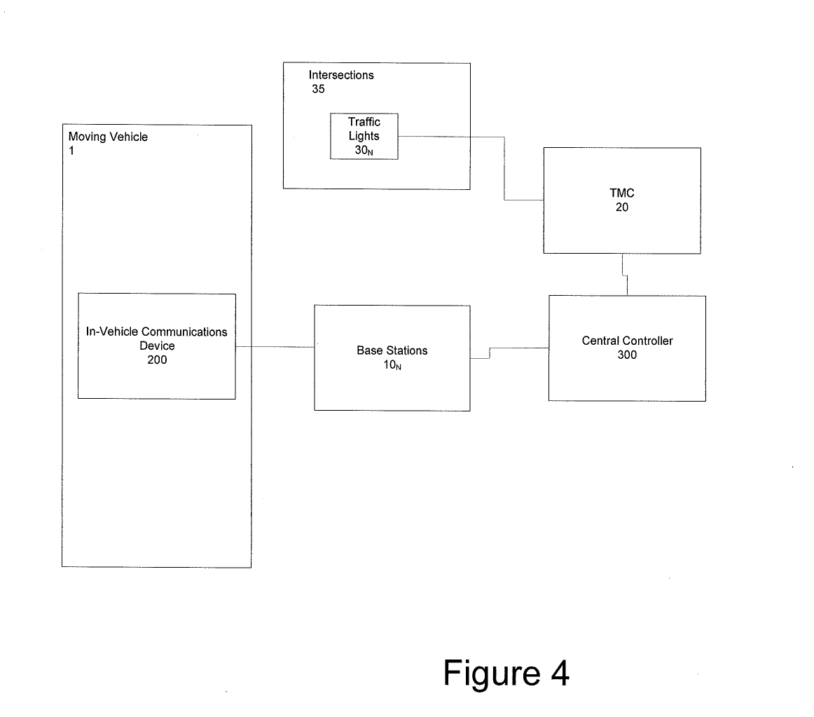

FIG. 4 illustrates a block diagram of the vehicle collision avoidance system 100. The moving vehicle 1 includes an in-vehicle communications device 200. The in-vehicle communications device 200 is configured to support bi-directional communication with the central controller 300 via at least one serving base station 10. Similarly, the central controller 300 is configured to support bi-directional communication with each of the in-vehicle communication devices 200 via at least one serving base station 10. The TMC 20 controls the phase and timing of the traffic lights 30 at each intersection 35. This control information is transmitted, via a wired or wireless connection to the central controller 300. The central controller 300 transmits this control information to an in-vehicle communications device 200 when a connection is established.

FIG. 4 illustrates only one TMC 20 however, the system 100 is not limited to one TMC 20. In a city, there may be multiple TMCs 20 deployed. The central controller 300 is configured to communicate with each of the TMCs 20. In the case that there are multiple TMCs 20, the central controller 300 can determine which TMC 20 to contact to obtain the SPAT information based upon a location of the requesting vehicle 1, i.e., location of in-vehicle communications device 200.

For purposes of this description, the location of the vehicle 1 and location of the in-vehicle communications device 200 is used interchangeably. When either the in-vehicle communications device 200 or the central controller 300 determines the location and speed, they assume that the location of the vehicle 1 is the same as the location of the in-vehicle communications device 200.

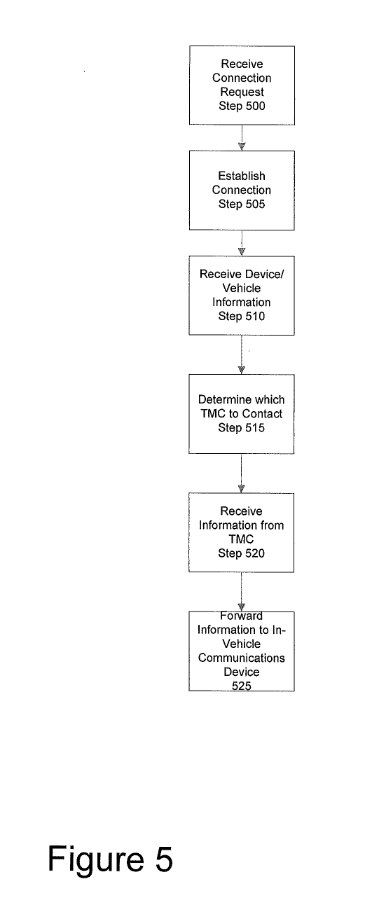

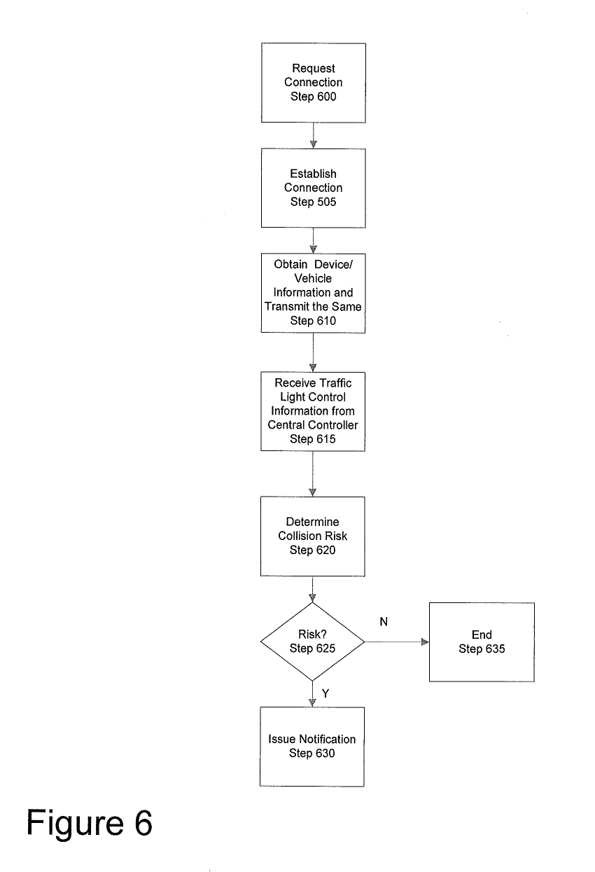

FIGS. 5 and 6 illustrate flow charts for a collision avoidance method according to a first example of the invention.

FIG. 5 illustrates functions performed in the central controller 300. FIG. 6 illustrates functions performed in the in-vehicle communications device 200. In this example, the in-vehicle communications device 200 calculates the speed of the vehicle 1 and determines a risk of collision.

At step 500, the central controller 300 receives a connection request from an in-vehicle communications device 200 via a serving base station 10 which is covers the location in which the vehicle 1 is currently located, i.e., near an intersection. The connection request identifies the in-vehicle communications device 200 by the identifier. The connection request is for a point-to-point connection with the central controller 300. At step 505, an active connection is established via the serving base station 10. Bandwidth in the serving base station is allocated for the in-vehicle communications device 200. The connection is a bi-directional connection. The uplink connection, i.e., from in-vehicle communications device 200 to central controller 300 is a uni-cast connection. The downlink connection, i.e., from the central controller 300 to the in-vehicle communications device 200 can be a uni-cast, multi-cast or broadcast connection.

Once an uplink connection is established, the central controller 300 periodically receives location information from the in-vehicle communications device 200 at step 510. The information includes the driving speed, driving direction, and current location.

If there is more than one TMC 20, the central controller 300 uses the driving speed, driving direction, and current location to determine which TMC 20 is the appropriate TMC 20 (i.e., local TMCs) to contact to obtain the SPAT information for the traffic lights at the relevant intersection 35, at step 515. For example, TMC 20 generates the traffic signal phase and timing plans for traffic lights TF1, TF2, TF3 and TF4 35₁₋₄. The central controller 300 obtains from the TMC 20 SPAT information of traffic lights TF1 to TF4. The central controller 300 can use any network technology, including wireless and wired networks, to obtain traffic SPAT information via the first data communications interface system 315. If there is only one TMC 20, step 515 is omitted. At step 520, the SPAT information is received from the appropriate TMC 20.

The central controller 300 sends the SPAT information for the relevant intersection 35 to the in-vehicle communications device 200 at step 525. The central controller 300 sends the SPAT information to the vehicles over the point-to-point (uni-cast) cellular connection with the vehicle 1 previously established. Alternatively, the central controller 300 can periodically broadcast the SPAT information. The connection remains active for the central controller 300 to periodically receive updated location, speed and direction information from the device vehicle 1.

At step 600, the in-vehicle communications device 200 issues a connection request containing its unique identifier. This connection request is sent to the central controller 300 via the serving base station 10. The connection request is triggered when the vehicle 1 is within a predetermined distance from an intersection 35. The CPU 205 continuously determines if the vehicle 1 is within the predetermined distance. The location determining section 215 such as a GPS receiver sends the geo-location information to the CPU 205. The geo-location information includes a current location of the vehicle and location of the traffic intersection. The CPU 205 determines the distance from the traffic intersection whose location is registered in the storage section 210 and compares the determined distance with the predetermined distance. If the determined distance is equal to the predetermined distance, the CPU 205 causes the radio/antenna system 225 to issue a connection request with the central controller 300.

If the in-vehicle communications device 200 receives a positive reply to the connection request from the central controller 300, a connection is established at step 505. For purposes of the description, the same step numbers (reference numbers) are used for similar steps.

At step 610, the CPU 205 obtains current direction, speed and location information from the location determining section 215 and/or via the vehicle I/O 235. Speed information can be received from the vehicle odometer. Alternatively, the CPU 205 can calculate an instantaneous speed using two successive positions and directions information and a timer.

The location information is transmitted to the central controller 300 by the radio/antenna system 225 under the control of the CPU 205 via the assigned serving base station 10. The CPU 205 internally sends the location information via a communications bus 230 to the radio/antenna system 25. The serving base station 10 can change once a connection is established based upon the base station coverage. If there is a change, the in-vehicle communications device 200 will be handed over to the new serving base station 10 using a known technique which will not be described herein in detail.

At step 615, the in-vehicle communications device 200 receives the SPAT information for the relevant traffic intersection 35 from the central controller 300 via the assigned serving base station 10.

Using the SPAT information received, together with its own location and speed information, the CPU 205 determines whether there will be a hazardous condition such as whether the vehicle 1 will likely run the red light at the intersection 35 at step 620. The CPU 205 calculates an expected time to reach the traffic intersection 35. The expected time is based upon the current position, current time, direction of travel and the current speed. The SPAT information indicates the time and phase of the traffic light 30, e.g., a time for a red light. The expected time is compared with the SPAT information. If there is a collision risk (“Y” at step 625), the driver is alerted at step 630. The notification or alert can be sounds via the speakers 245, a visible displayed alert via the display 240 and/or seat vibrations controlled via the vehicle I/O 235 to notify the driver of imminent danger. The CPU 205 can also intercept any other communications the in-vehicle communications device 200 is engaged in, in order to draw the attention of the driver. If a determination is made where there is no risk (“N” at step 625), the CPU 205 terminates the process at step 635.

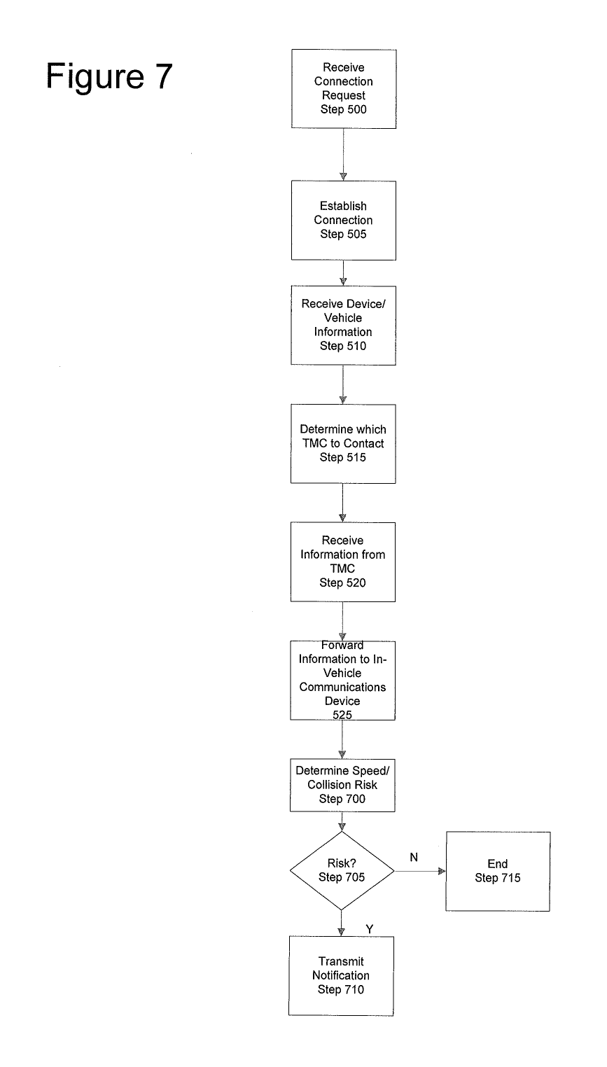

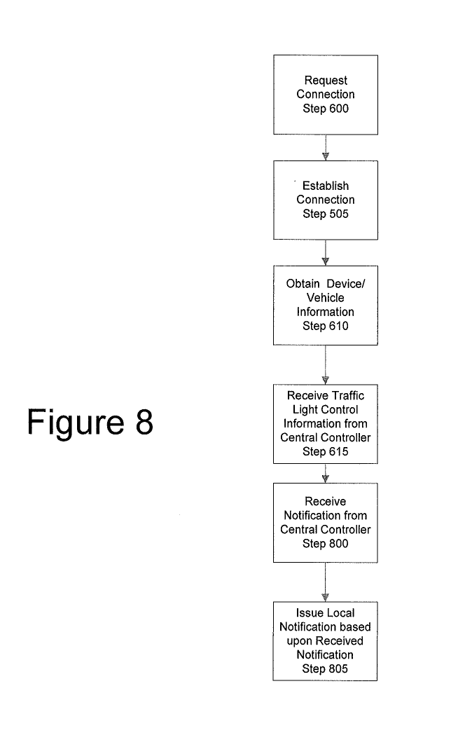

FIGS. 7 and 8 illustrate flow charts for a collision avoidance method according to a second example of the invention. FIG. 7 illustrates functions performed in the central controller 300. FIG. 8 illustrates functions performed in the in-vehicle communications device 200. In this example, the central controller 300 calculates the speed of the vehicle 1 (if necessary) and determines a risk of collision instead of the in-vehicle communications device 200.

Many of the steps depicted in FIGS. 7 and 8 are the same as the first example and will not be described again in detail. For example, Steps 500-525 are the same as described above.

At step 700, the central controller 300 (using CPU 305) computes the vehicle speed based on location information received from the in-vehicle communications device 200 (if necessary). Based on traffic SPAT information received from the TMC 20, the CPU 305 decides whether it should notify the in-vehicle communications device 200 of a collision risk. For example, the CPU 305 predicts whether a vehicle approaching the intersection 35 will have enough time to stop before the traffic light 30 turns red. The prediction uses an expected time of arrival at the intersection 35 and the timing of the traffic light 30 turning red. The expected time of arrival is calculated in the same manner as described above and will not be described again in detail.

If danger is detected (“Y” at step 705), the CPU 305 can cause the second data communications interface system 320 to send a danger alert to the in-vehicle communications device 200 through the existing cellular connections at step 710. If not (“N” at step 705), the CPU 305 terminates the process at step 715.

Steps 600, 505, 610 and 615 in the in-vehicle communications device 200 are the same as in the first example and will not be described again in detail.

At step 800, the in-vehicle communications device 200 receives the notification or alert from the central controller 300 via the assigned serving base station 10.

Once a danger alert is received by the radio/antenna system 225 in the in-vehicle communications device 200, it is internally sent to the CPU 205 via the communications bus 230. The CPU 205 issues a local notification or alert to the driver at step 805. The local notification or alert can be sounds via the speakers 245, a visible displayed alert via the display 240 and/or seat vibrations, controller via the vehicle I/O 235 to notify the driver of imminent danger. Additionally, as described above, the CPU 205 can also intercept any other communications the in-vehicle communications device 200 is engaged in, in order to draw the attention of the owner/driver.

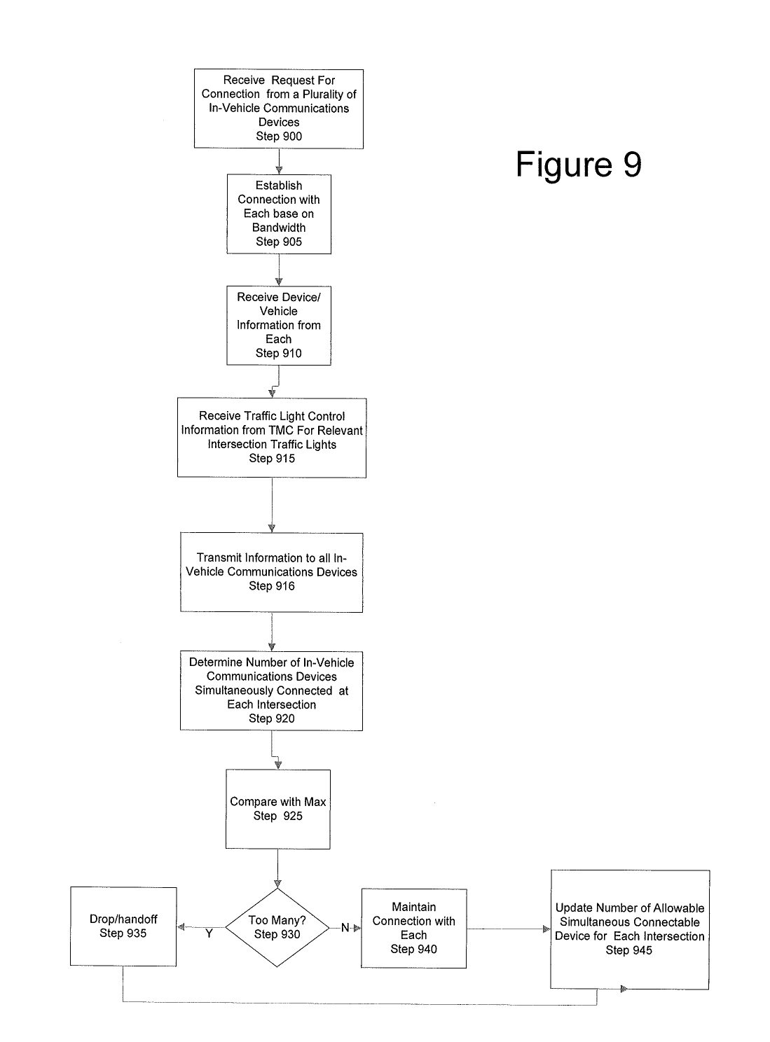

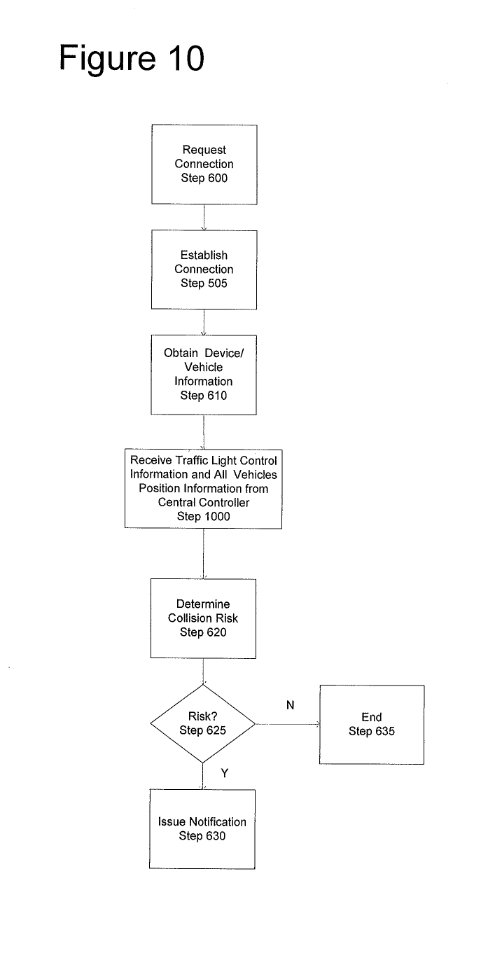

FIGS. 9 and 10 illustrate flow charts for a collision avoidance method according to a third example of the invention. FIG. 9 illustrates functions performed in the central controller 300. FIG. 10 illustrates functions performed in the in-vehicle communications device 200. The third example of the invention differs from the first and second examples in that multiple in-vehicle communications devices 200_{N} request simultaneous connection with the central controller 300 via at least one serving base station 10 from multiple traffic intersections 35_{N}.

In this example, the central controller 300 receives location information from multiple vehicles and relays this information to all vehicles 1 approaching the relevant intersections e.g., 35. The in-vehicle communications device 200 determines a risk of collision based upon the received SPAT information, its own location information and the received location information for other vehicles at the relevant traffic intersection e.g., 35.

At step 900, the central controller 300 receives a connection request from a plurality of in-vehicle communications devices 200_{N}. If there is available bandwidth, a connection is established with each in-vehicle communications device 200 at step 905. If the available bandwidth is not available, the steps 920-945 can be triggered to reallocate bandwidth within each base station 10. Bandwidth is reallocated by handing off in-vehicle communications devices 200 to other base stations. Additionally, the bandwidth is reallocated by selectively dropping or disconnecting active connections. Both of these processes will be described in detail later. In this case, the connection request can be delayed.

Once a connection is established, the central controller 300 periodically receives location information from each of the in-vehicle communications devices 200 at step 910. The location information can be driving speeds, driving directions, and current locations. At step 915, the CPU 305 causes the first radio/antenna system 315 to acquire the SPAT information for each of the relevant traffic intersections 35_{N} and traffic lights 30_{N} from the TMC(s) 20. The CPU 305 uses the driving speeds, driving directions and current locations for each vehicle 1 to determine the appropriate relevant traffic intersections 35_{N} and traffic lights 30_{N} and the appropriate TMC 20.

At step 915, the central controller sends the traffic SPAT information for appropriate intersection e.g., 35, and the location, speed, and driving direction information for all vehicles approaching the intersection to each connected vehicle 1 at the appropriate intersection e.g., 35. The central controller 300 using the second radio/antenna system 320 can send the information to the vehicles 1 over the point-to-point (uni-cast) cellular connections established previously for each vehicle 1. The information can be sent via a uni-cast, a multi-cast or a broadcast. If broadcast, the central controller 300 sends the information to each of the serving base stations 10 (relevant to the intersections 35) and the serving base stations 10 will broadcast the message which will be heard by all in-vehicle communications devices 200 within the corresponding cells 15.

At step 920, the central controller 300 determines a total number of in-vehicle communications devices 200 having an active connection that is simultaneously connected to the central controller 300 near each intersection. This is done to support efficient usage of a limited number of simultaneously available network connections. There are only a limited number of connections, typically around a few hundreds, can be supported simultaneously in a given area. However, in an urban area, there may be thousands of vehicles in the area. The determined total number of in-vehicle communications devices 200 is compared with a maximum number of allowable or available simultaneous connections for a given intersection at step 925. If the determined number is equal to or larger than the maximum available simultaneous connections (“Y” at step 930), the central controller 300 using the CPU 305 causes certain in-vehicle communications devices 200 to be dropped from an active connection (or establish a connection if triggered at step 900) (step 935). Specific in-vehicle communications devices 200 are selected to be dropped (or connected) based upon at least one selection criterion. For example, the selection criterion can be a first-come-first-service basis that allow the vehicles 1 closest to an intersection 35 to maintain connection, i.e., newer connected devices are dropped or are not connected.

Alternatively, a random selection procedure in which a subset of all vehicles (in-vehicle communications and devices 200) approaching an intersection is selected to be dropped/connected.

Alternatively, the CPU 305 examines the location information received from each of the in-vehicles communication devices 200 and the SPAT information and examines a risk of collision to determine which in-vehicle communications devices 200 should be connected/maintained dropped. Additionally, if the number of simultaneous active connections is larger than the maximum available simultaneous connections, certain in-vehicle communications device 200 can be handed off to other base stations that have overlapping cells.

If the number of in-vehicle communications devices 200 simultaneously connected is less than the maximum (“N” at step 930), all active connections are maintained and new connections are allowed at step 940.

Steps 925-940 are illustrates as being “after” step 915, however, the balancing can be done at any time, e.g., during initial connection request.

At step 945, each intersection 35 is evaluated for load balancing. The load balancing at the central controller 300 is based upon traffic patterns and traffic density at a given time. Using data regarding the vehicle density at each intersection, the available resources is allocated among the intersections 35. The number of vehicles having an active connection can be optimized to ensure end-to-end latency and scalability. Additionally, the loading balance can be achieve by reallocating simultaneous allowable connects to different intersections, e.g., changing a maximum number of simultaneous connections for each intersection. For example, if there are two intersections (I1 and I2) and there are 10 vehicles in near I1 and I5 vehicles near I2, the central controller can determine that only 10 of the vehicles near I2 can have a simultaneous connection. Additionally, if the same two intersections initially allow 10 simultaneous connections each, the number of simultaneous connection can be changed to allow 15 for I1 and 5 for I2. Load balancing and the maximum simultaneous connection are used to insure a short end-to-end latency for vehicle collision avoidance. This is due to the high speed in which vehicles' travel. To support vehicle safety applications, a vehicle 1 typically needs to send messages including driving speed, driving direction, and current location using the in-vehicle communications device 200 to the central controller 300. The central controller 300 also needs to send messages to in-vehicle communications devices 200. The end-to-end latency normally should very small (for an indicative example, less than 100 ms) to support collision avoidance.

As noted above in step 915, the central controller 300 transmits the relevant information to the in-vehicle communications device 200. Effectively, the central controller 300 acts as an “information bridge” among the vehicles 1 approaching an intersection 35. The central controller 300 transmits SPAT information to vehicles (in-vehicle communications device 200) approaching the intersection 35 and collects and location/speed information from each vehicle 1 approaching the intersection 35 and then send the aggregate information to all vehicles approaching the intersection 35.

ach in-vehicle communications device 200 receives the information at step 1000 via the radio/antenna system 225. The information is internally sent to the CPU 205 via the communications bus 230. The CPU 205 determines a collision risk for the vehicle 1 based upon the information that it received from the central controller 300 and current location and speed information obtained by the location determining section 215 such as GPS receiver and/or vehicle I/O 235 for speed. The CPU 205 determines a series of expected locations for the vehicle 1 based upon its current location and speed and time. The CPU 205 determines the same for each of the vehicles 1 in which it received location/speed information. Additionally, the CPU 205 uses the SPAT information to determine if any vehicle is likely to not be able to stop in time for a red light. If another vehicle is expected to be in the substantially same location as the vehicle, or any vehicle is not likely to stop, there is a risk of collision. If there is a risk of a collision (“Y” at step 625), a notification or alert is issued to the driver as described above and will not be described again. Steps 600-610 illustrated in FIG. 10 are the same as described in the first example.

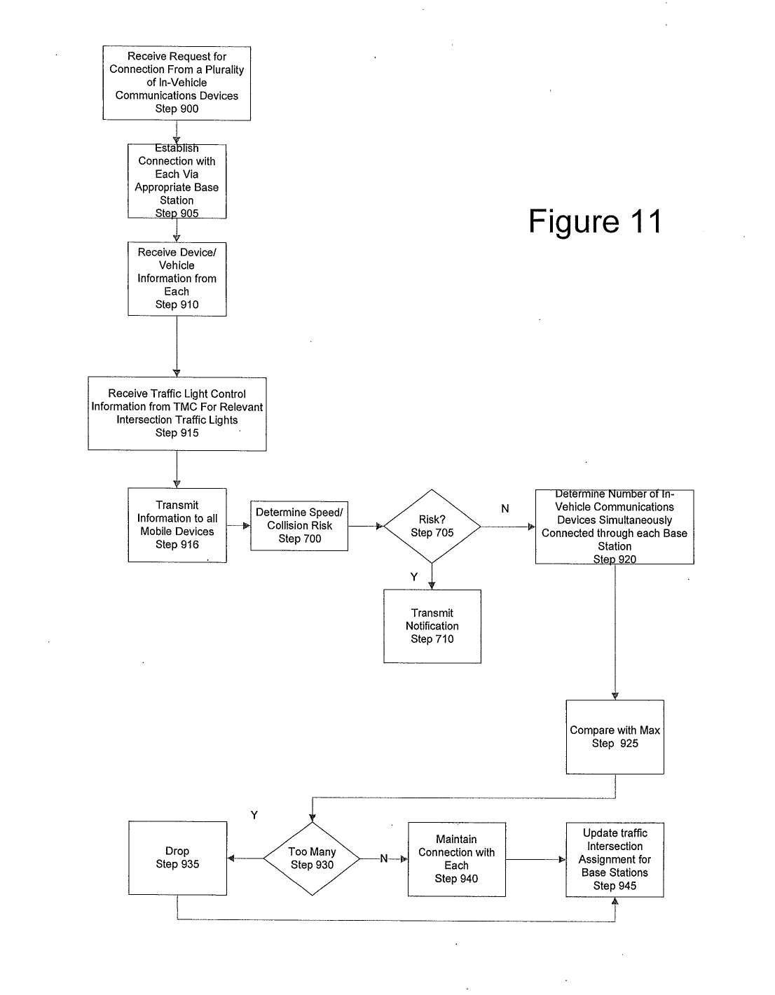

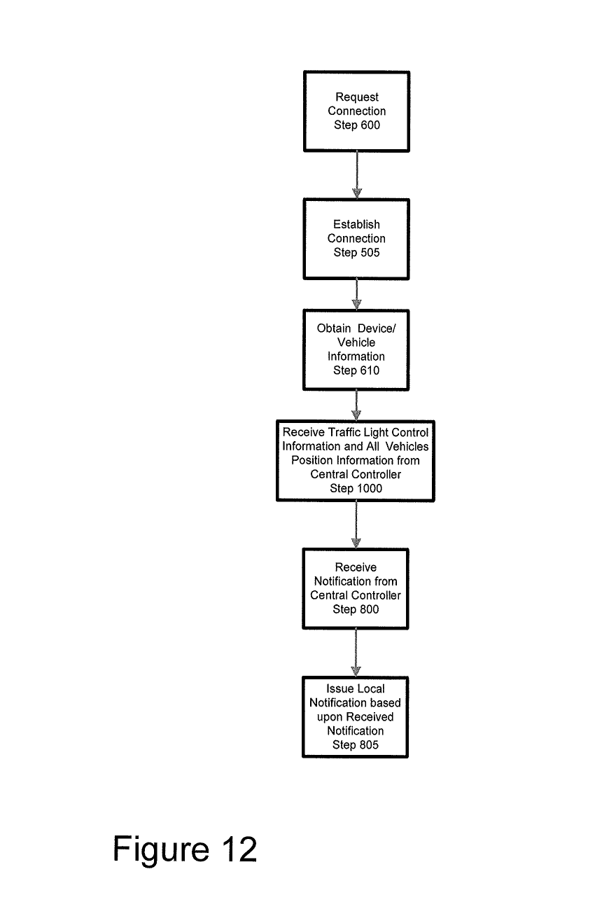

FIGS. 11 and 12 illustrate flow charts for a collision avoidance method according to a fourth example of the invention. FIG. 11 illustrates functions performed in the central controller 300. FIG. 12 illustrates functions performed in the in-vehicle communications device 200. In this example, the central controller 300 calculates the speed of each vehicle (if necessary) and determines a risk of collision for each vehicle 1 based upon all of the location information received from each in-vehicle communications device 200 instead of the in-vehicle communications device 200 as in the third example. The other steps are the same. The prediction or determination of the risk is the same as described for the third example.

Additionally, the central controller 300 can use the broadcast capability provided by the base stations 10 to broadcast the intersection collision avoidance information such as SPAT, location information and collision risk prediction to the vehicles 1 (in-vehicles communications devices 200). The central controller 300 looks up the locations of traffic lights 30, e.g., TF1 to TF4 and determines one or more cellular base stations 10, e.g., BS1 and BS2, which have cells 15 over the traffic lights 30, e.g., TF1 to TF4 concerned. The central controller 300 sends collision avoidance information to base stations 10, e.g., BS1 and BS2, which in turn deliver the information to in-vehicle communications devices 200 using broadcast or multi-cast. As vehicles 1, e.g., V1 and V2 from FIG. 1, enter the cells 15 base stations 10, e.g., BS1 and BS2, the in-vehicle communications device 200 receive the collision avoidance information broadcast by these base stations 10, e.g., BS1 and BS2.

As described above, when a vehicle 1 is approaching an intersection 35 and is still a predetermined distance D away from the intersection 35, the in-vehicle communications device 200 establishes a connection to the central controller 300 to send its current position, speed, and driving direction information, together with its contact information (e.g., its cellular phone number and/or IP address) to the central controller 300. The distance D is chosen in a way that will give sufficient time for the vehicle 1 to establish cellular network connections with the central controller 300 before the vehicle 1 reaches the intersection 35. This distance D can be varied over time by both the in-vehicle communications device 200 and the central controller 300 based upon a speed limit, traffic pattern, type of road, number of lanes of traffic, traffic density, time of day, etc. For example, if the central controller 300 determines that there is a high traffic volume, the distance D can be increased. Additionally, if the speed limit is high, the distance D can be increased. When the distance D is changed, the change is transmit to the other device, i.e., from central controller 300 to in-vehicle communications device 200, and vice versa.

Various aspects of the present disclosure may be embodied as a program, software, or computer instructions embodied or stored in a computer or machine usable or readable medium, which causes the computer or machine to perform the steps of the method when executed on the computer, processor, and/or machine. A program storage device readable by a machine, e.g., a computer readable medium, tangibly embodying a program of instructions executable by the machine to perform various functionalities and methods described in the present disclosure is also provided.

The exemplary system, devices and methods described herein may be implemented and run on a general-purpose computer or special-purpose computer system. The system and devices may be any type of known or will be known systems and may typically include a processor, memory device, a storage device, input/output devices, internal buses, and/or a communications interface for communicating with other computer systems in conjunction with communication hardware and software, etc.

The computer readable medium could be a computer readable storage device or a computer readable signal medium. Regarding a computer readable storage device, it may be, for example, a magnetic, optical, electronic, electromagnetic, infrared, or semiconductor system, apparatus, or device, or any suitable combination of the foregoing; however, the computer readable storage medium is not limited to these examples. Additional particular examples of the computer readable storage device can include: a portable computer diskette, a hard disk, a magnetic storage device, a portable compact disc read-only memory (CD-ROM), a random access memory (RAM), a read-only memory (ROM), an erasable programmable read-only memory (EPROM or Flash memory), an electrical connection having one or more wires, an optical fiber, an optical storage device, or any appropriate combination of the foregoing; however, the computer readable storage medium is also not limited to these examples. Any tangible medium that can contain, or store a program for use by or in connection with an instruction execution system, apparatus, or device could be a computer readable storage device.

The terms “system” and “network” and “devices” as may be used in the present application may include a variety of combinations of fixed and/or portable computer hardware, software, peripherals, and storage devices. The “system” and “devices” may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module or section may be a component of a device, software, program, or system that implements some “functionality”, which can be embodied as software, hardware, firmware, electronic circuitry, or etc.

The system, devices and methods described above are illustrative examples and it should not be construed that the present invention is limited to these particular embodiments. Thus, various changes and modifications may be effected by one skilled in the art without departing from the spirit or scope of the invention as defined in the appended claims.

What is claimed is:

1. A method of avoiding vehicle collisions comprising:
receiving a connection request from an in-vehicle device within a moving vehicle when the moving vehicle is within a selected distance from a traffic intersection;
establishing connection with the in-vehicle device within a moving vehicle via a serving base station;
receiving position information from the in-vehicle device within a moving vehicle corresponding to a position of the moving vehicle;
receiving control information for a traffic light at the traffic intersection from a traffic management center; and
relaying the control information for the traffic light to the in-vehicle device within a moving vehicle.

2. The method of avoiding vehicle collisions according to claim 1, wherein the position information is periodically received once a connection is established.

3. The method of avoiding vehicle collisions according to claim 2, further comprising:
determining a speed of the moving vehicle based upon the periodically received position information;
determining if a notification to an in-vehicle device within a moving vehicle should be issued based upon the determined speed and the received position information; and
transmitting the notification to the in-vehicle device based upon the determination.

4. The method of avoiding vehicle collisions according to claim 1, wherein a connection request is received from a plurality of in-vehicle devices, each of the plurality of in-vehicle devices being within a corresponding moving vehicle, the method further comprising:
establishing connection with each of the plurality of in-vehicle devices via at least one serving base station based on available bandwidth;
receiving position information from each of the plurality of in-vehicle devices corresponding to a position of each of corresponding moving vehicles;
receiving control information for at least one traffic light at a corresponding traffic intersection from a traffic management center, the corresponding traffic intersection being determined based upon the position information of each of the plurality of in-vehicle devices; and
relaying the control information for the at least one traffic light at the corresponding traffic intersection to each of the plurality of in-vehicle devices via the at least one serving base station.

5. The method of avoiding vehicle collisions according to claim 4, further comprising:
transmitting the position information from each of the plurality of in-vehicle devices received, as an aggregate position information for each of the plurality of in-vehicle devices, to each of the plurality of in-vehicle devices.

6. The method of avoiding vehicle collisions according to claim 4, further comprising:
determining a speed for each of a corresponding vehicles;
determining if a notification to an in-vehicle device within a moving vehicle should be issued based upon the determination for each of the corresponding moving vehicles and the position information received; and
transmitting the notification to each of said plurality of in-vehicle devices based upon said determination.

7. The method of avoiding vehicle collisions according to claim 6, further comprising:
determining a total number of in-vehicle devices having an active connection at each intersection;
comparing the total number of in-vehicle devices with a maximum number simultaneously connectable in-vehicle devices; and
dropping a sub-set of in-vehicle devices from the active connection based upon said determination.

8. The method of avoiding vehicle collisions according to claim 7, wherein said dropping is based upon a current location of an in-vehicle device and a current speed of the corresponding moving vehicle.

9. The method of avoiding vehicle collisions according to claim 7, wherein said dropping is based upon a random selection of an in-vehicle device.

10. The method of avoiding vehicle collisions according to claim 1, further comprising:
determining the selected distance based upon traffic patterns and traffic density.

11. A method of avoiding vehicle collisions comprising:
issuing a connection request to a central controller from a moving vehicle when a moving vehicle is within a selected distance from a traffic intersection;
establishing connection with the central controller via a serving base station;
obtaining position information for the moving vehicle and transmitting the same to the central controller; and
receiving control information for a traffic light at the traffic intersection from the central controller.

12. The method of avoiding vehicle collisions according to claim 11, further comprising:
determining if a warning should issue based upon the position information and control information for a traffic light received; and
generating a warning based upon the determining.

13. The method of avoiding vehicle collisions according to claim 11, further comprising:
receiving position information for all other vehicles within a distance of the traffic intersection;
determining if a warning should issue based upon the position information, the position information for all other vehicles within a distance of the traffic intersection received and control information for a traffic light received; and
generating a warning based upon said determining.

14. The method of avoiding vehicle collisions according to claim 11, wherein the position information includes a speed, a direction of travel and current location.

15. The method of avoiding vehicle collisions according to claim 11, wherein the control information for a traffic light includes phase and time data.

16. The method of avoiding vehicle collisions according to claim 11, wherein position information is periodically transmitted once a connection is established.

17. The method of avoiding vehicle collisions according to claim 14, further comprising:
determining the selected distance based upon a current speed of a moving vehicle.

18. The method of avoiding vehicle collisions according to claim 12, further comprising:
terminating any non-collision avoiding communications for an in-vehicle device prior to generating the warning.

19. A vehicle collision avoidance management device comprising:
a processor configured to, when executing computer readable instructions provide:
a connection management section configured to manage simultaneous connectivity of a plurality of in-vehicle devices within moving vehicles with said vehicle collision avoidance management device based upon a number of the plurality of in-vehicle devices within moving vehicles having active connections with said vehicle collision avoidance management device at a given time through each of a plurality of serving base stations;
a first receiving section configured to receive traffic signal control information for traffic signals at each of a plurality of traffic intersections;
a second receiving section configured to receive communications from each of a plurality of in-vehicle devices within moving vehicles when a corresponding vehicle is within a selected distance of an intersection, the communications including location information; and
a transmitting section configured to transmit the traffic signal control information for traffic signals to each of the plurality of in-vehicle devices and to transmit the communications received from each of the plurality of in-vehicle devices to each of the other of the plurality of in-vehicle devices.

20. The vehicle collision avoidance management device according to claim 19, further comprising:
a collision detection section configured to generate a collision warning to at least one of the plurality of in-vehicle devices based upon the traffic signal control information and the communications received from each of the plurality of in-vehicle devices, wherein said transmitting section is configured to transmit the collision warning to at least one of the plurality of in-vehicle devices.

21. The vehicle collision avoidance management device according to claim 19, wherein said connection management section is configured to selectively drop a sub-set of in-vehicle devices from the active connection when a number of active connections exceed a variable maximum number.

22. The vehicle collision avoidance management device according to claim 21, wherein the drop is based upon a current location of an in-vehicle device and current speed of a corresponding moving vehicle.

23. The vehicle collision avoidance management device according to claim 21, wherein the drop is based upon a random selection of an in-vehicle device.

24. The vehicle collision avoidance management device according to claim 19, further comprising a distance determining section configured to periodically determine the selected distance based upon traffic patterns and traffic density.

25. A computer readable storage device having computer readable instructions for causing a processor to execute a method of:
receiving a connection request from an in-vehicle device within a moving vehicle when the moving vehicle is within a selected distance from a traffic intersection;
establishing connection with the in-vehicle device within the moving vehicle via a serving base station;
receiving position information from the in-vehicle device within the moving vehicle corresponding to a position of the moving vehicle;
receiving control information for a traffic light at the traffic intersection from a traffic management center; and
relaying the control information for the traffic light to the in-vehicle device within a moving vehicle.

26. A computer readable storage device having computer readable instructions for causing a processor to execute a method of:
issuing a connection request to a central controller from a moving vehicle when a moving vehicle is within a selected distance from a traffic intersection;
establishing connection with the central controller via a serving base station;
obtaining position information for the moving vehicle and transmitting the same to the central controller; and
receiving control information for a traffic light at the traffic intersection from the central controller.

27. The computer readable storage device according to claim 26, wherein the method further comprises:
receiving position information for all other vehicles within a distance of the traffic intersection;
determining if a warning should issue based upon the position information, the position information for all other vehicles within a distance of the traffic intersection received and the control information for a traffic light received; and
generating a warning based upon said determining.
